(19) United States
(12) Patent Application Publication
(10) Pub. No.: US 2015/0046883 A1
(43) Pub. Date: Feb. 12, 2015

(54) METHOD OF DISPLAYING CLASSIFIED INFORMATION AND DEVICE OF DISPLAYING CLASSIFIED INFORMATION USING THE SAME

(71) Applicant: SAMSUNG ELECTRO-MECHANICS CO., LTD., Gyeonggi-Do (KR)

(72) Inventors: Hee Yong YOO, Suwon-si (KR); Sam Ki JUNG, Suwon-si (KR)

(73) Assignee: SAMSUNG ELECTRO-MECHANICS CO., LTD., Gyeonggi-Do (KR)

(21) Appl. No.: 14/229,173

(22) Filed: Mar. 28, 2014

(30) Foreign Application Priority Data
Aug. 12, 2013 (KR) 10-2013-0095415

(51) Int. Cl. G06F 3/0484; G06F 17/30

(52) U.S. Cl. CPC G06F 3/04842; G06F 17/30221
USPC 715/854

(57) ABSTRACT

Embodiments of the invention provide a method and device for displaying classified information. In accordance with an embodiment, the method includes generating a first auxiliary line, which is a closed curve, and a second auxiliary line, which does not overlap with the first auxiliary line and surrounds a larger surface than an area of a surface surrounded by the first auxiliary line. The method further includes displaying a folder screen generated by disposing at least one first layer folder on the first auxiliary line and disposing at least one second layer folder on the second auxiliary line, wherein the second layer folder is a sub-folder of the first layer folder.

### CROSS REFERENCE TO RELATED APPLICATION

This application claims the benefit of and priority under 35 U.S.C. §119 to Korean Patent Application No. KR 10-2013-0095415, filed on Aug. 12, 2013, which is hereby incorporated by reference in its entirety into this application.

### BACKGROUND

1. Field of the Invention

The present invention relates to a method of displaying classified information and a device of displaying classified information using the same.

2. Description of the Related Art

Image devices with various display panels are becoming widespread.

Owing to the rapid development of related technologies, such as processors, memory, display devices, and communication technologies, image devices are becoming smaller, slimmer, high-effective, and multifunctional.

For example, the memory that store information can store much more data than before, while continuously becoming smaller. Accordingly, there is a need for a method of finding the corresponding information, for example, a file quickly when necessary by effectively managing a lot of information such as files.

Generally, in order to effectively manage many files, the files are classified through layered folders, and the layered folders like this are displayed on a screen in the form of a tree to allow a user to find the desired file.

Meanwhile, due to the increase in smartphone and tablet users, the importance of interactive graphic user interface (GUI) environment, which effectively displays information and responds to the users in a limited screen space, is increasing day by day.

Accordingly, a more efficient method of searching and exploring user's desired information by touching a display screen like smartphones and tablet PCs is being developed.

Like the PC, it is common that information configured in the smartphones or tablet PCs is displayed in a tree structure and moved like a parent-child relationship. Thus, an effective moving method between information configured as a hierarchical relationship should consider several situations, such as a situation in which a limited display space should be effectively used, while not causing a user's confusion during movement.

As a representative method of representing classified information having a parent-child relationship, there is an explorer program for PC. This program provides, for example, a user interface environment that effectively represents a hierarchical relationship between folders (or directories), which contain file information, to users. Further, a scroll concept is introduced to complement display space constraints in displaying a large amount of folders on one screen.

Through this explorer program, PC users can process works by easily moving to the desired folder and finding the desired file in the corresponding folder.

It can be understood that the basic data structure is hierarchical information configured as a parent-child relationship.

However, since the image devices, such as smartphones and tablets, which have a relatively smaller screen than PCs, can store and use tens to tens of thousands of files, these devices are also needed to classify many files using folders having a hierarchical structure.

However, since the mobile electronic devices, such as smartphones or tablet PCs have a relatively smaller screen than PCs, it is difficult to display the hierarchical folders in a tree format.

Thus, in order to display the tree of the folders consisting of many layers on a limited screen, since information such as folders or folder names should be reduced, the number of the folders or folder layers, which can be displayed on one screen, cannot but be limited.

Therefore, typical conventional mobile electronic devices employ a method of arranging files in one direction or in an icon form and displaying a directory path of the corresponding folder on the top or bottom of a screen in a sentence form.

However, these conventional folder display methods have a problem that there are limits to allow users to recognize a hierarchical structure of the folders intuitively and quickly.

### SUMMARY

Accordingly, embodiments of the present invention are provided to overcome the above-described problems and it is, therefore, an object of embodiments of the present invention to provide a method of displaying classified information and a device for displaying classified information using the same that can intuitively recognize and search a plurality of folders having a hierarchical structure and files included in the respective folders.

Embodiments of the present invention provide a method of displaying classified information, including generating a first auxiliary line, which is a closed curve, and a second auxiliary line, which does not overlap with the first auxiliary line and surrounds a larger surface than an area of a surface surrounded by the first auxiliary line. The method further includes displaying a folder screen generated by disposing at least one first layer folder on the first auxiliary line and disposing at least one second layer folder on the second auxiliary line, wherein the first auxiliary line and the second auxiliary line are closed curves and the second layer folder is a sub-folder of the first layer folder.

In accordance with an embodiment of the invention, the first auxiliary line and the second auxiliary line share a center point positioned in a center of the folder screen.

In accordance with an embodiment of the invention, a root folder, which is a parent folder of the first layer folder, is disposed in the center point.

In accordance with an embodiment of the invention, the method of displaying classified information further includes displaying the folder screen in such a way that the smaller the distance from the first auxiliary line to the center point, the larger the size of the first layer folder and the smaller the distance from the second auxiliary line to the center point, the larger the size of the second layer folder.

In accordance with an embodiment of the invention, the first auxiliary line and the second auxiliary line have a rectangular shape.

In accordance with an embodiment of the invention, the method of displaying classified information further includes positioning the double-touched folder in the center point and disposing a parent folder and a sub-folder of the double-touched folder on the first auxiliary line when one folder selected from the first layer folder and the second folder is double touched.

In accordance with an embodiment of the invention, the method of displaying classified information further includes displaying a preview which lists information of files included in the touched folder when the folder positioned in the center point is touched.

In accordance with an embodiment of the invention, the preview includes an index bar formed by continuously arranging icons of the files according to a predetermined order, and a file name display bar for displaying a file name of the file indexed on the index bar.

In accordance with an embodiment of the invention, the preview further includes a file number consisting of the total number of the files and a number of the file indexed on the index bar.

In accordance with an embodiment of the invention, the method of displaying classified information further includes displaying an outline of the touched folder when one folder selected from the first layer folder and the second layer folder is touched, and changing the size of the touched folder according to a drag direction when the outline is dragged.

In accordance with an embodiment of the invention, the method of displaying classified information further includes changing the distance from the auxiliary line on which the touched folder is disposed to the center point according to the drag direction when the outline is dragged.

In accordance with an embodiment of the invention, the method of displaying classified information further includes changing the distance from the touched and dragged auxiliary line to the center point and the size of the folder disposed on the touched and dragged auxiliary line according to the drag direction when one auxiliary line selected from the first auxiliary line and the second auxiliary line is touched and dragged.

In accordance with another embodiment of the present invention, there is provided a method of displaying classified information that displays a folder screen generated by disposing at least one folder and a sub-folder of the folder on a plurality of auxiliary lines that are closed curves, which do not overlap with each other, and surround surfaces of different areas, respectively.

In accordance with an embodiment of the invention, the auxiliary lines are closed curves, which share a center point positioned in a center of the folder screen.

In accordance with an embodiment of the invention, a size of the folder disposed on the auxiliary line is changed when a circumferential length of one of the auxiliary lines is changed. In accordance with an embodiment of the invention, the size of the folder is proportional to a variation in the circumferential length of the auxiliary line.

In accordance with an embodiment of the invention, the auxiliary line has a rectangular shape.

In accordance with another embodiment of the present invention, there is provided a device of displaying classified information, including a display for outputting a folder screen, and a controller for generating the folder screen by generating a first auxiliary line and a second auxiliary line, disposing a first layer folder on the first auxiliary line, and disposing a second layer folder on the second auxiliary line.

In accordance with an embodiment of the invention, the device of displaying classified information further includes an input device having at least one selected from a touch screen, a keyboard, a mouse, a mike, and a sensor to receive a user's command, an input processor for processing a signal input through the input device, and a storage device for storing input data processed by the input processor and output data generated by the controller.

In accordance with an embodiment of the invention, the device of displaying classified information further includes an interface connector connected to the controller and the storage device to connect data, which forms folders and files, to the controller and the storage device.

In accordance with an embodiment of the invention, the input processor transmits the signal input through the input device to the storage device only when the signal satisfies a predetermined condition.

In accordance with another embodiment of the present invention, there is provided a device of displaying classified information, including a controller for generating a folder screen formed by disposing at least one folder and a sub-folder of the folder on a plurality of auxiliary lines that are closed curves, which do not overlap with each other, and surround surfaces of different areas, respectively, and a display for outputting the folder screen.

In accordance with an embodiment of the invention, the auxiliary lines are closed curves, which share a center point positioned in a center of the folder screen.

In accordance with an embodiment of the invention, a size of the folder disposed on the auxiliary line is changed when a circumferential length of one of the auxiliary lines is changed.

In accordance with an embodiment of the invention, the size of the folder is proportional to a variation in the circumferential length of the auxiliary line.

In accordance with an embodiment of the invention, the auxiliary line has a rectangular shape.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a block diagram schematically showing a device of displaying classified information in accordance with an embodiment of the present invention.

FIG. 2 is a view schematically showing a folder screen displayed in the device of displaying classified information in accordance with an embodiment of the present invention.

FIG. 3 is a view for explaining a principle that the size of a folder is increased in the folder screen in accordance with an embodiment of the present invention.

FIG. 4 is a view for explaining a principle that the size of the folder is reduced in the folder screen in accordance with an embodiment of the present invention.

FIG. 5 is a view for explaining a principle that the size of a folder is increased in a folder screen in accordance with another embodiment of the present invention.

FIG. 6 is a view showing a state in which the folder screen is rearranged around the folder selected in accordance with an embodiment of the present invention.

FIG. 7A is a view showing a state in which a preview is displayed on the folder screen of FIG. 6 in accordance with an embodiment of the present invention.

FIG. 7B is a view for explaining the preview of FIG. 7A in accordance with an embodiment of the present invention.

FIG. 8 is a view for explaining a principle of searching a file using a preview in accordance with an embodiment of the present invention.

FIG. 9 is a view for explaining a principle of searching a file using a preview in accordance with another embodiment of the present invention.

FIG. 10 is a flowchart schematically showing a method of displaying classified information in accordance with an embodiment of the present invention.

FIG. 11 is a flowchart for explaining a principle of searching classified information in accordance with an embodiment of the present invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

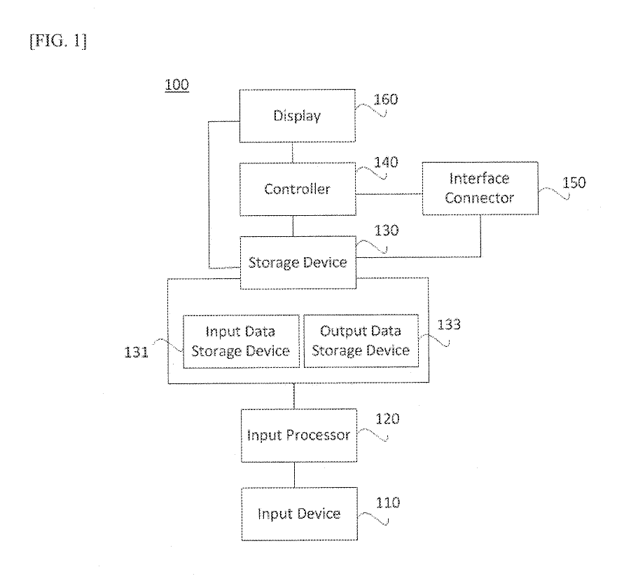

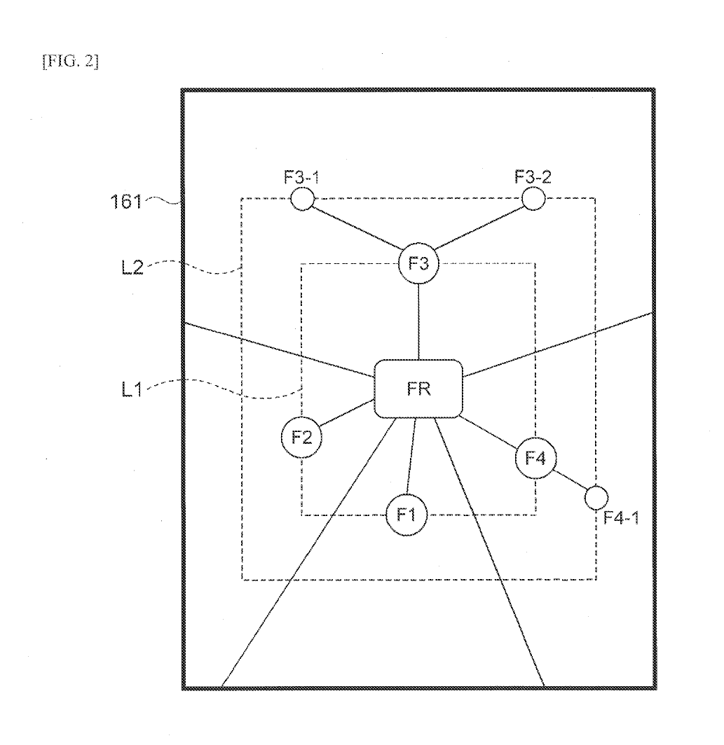

FIG. 1 is a block diagram schematically showing a device 100 for displaying classified information in accordance with an embodiment of the present invention, and FIG. 2 is a view schematically showing a folder screen 161 displayed in the device 100 for displaying classified information in accordance with an embodiment of the present invention.

Referring to FIGS. 1 and 2, the device 100 for displaying classified information, in accordance with an embodiment of the present invention, includes a controller 140 and a display 160 and further includes an input device 110, an input processor 120, a storage device 130, an interface connector 150.

In accordance with an embodiment, the controller 140 is configured to generate the folder screen 161 having auxiliary lines and folders disposed on the auxiliary lines.

In accordance with an embodiment, the auxiliary lines include virtual lines, which have different widths and do not overlap with each other and may include a first auxiliary line L1 and a second auxiliary line L2, as shown in FIG. 2. Further, although embodiments of the present invention, as described herein and shown in the figures, show the folder screen 161 having only the first auxiliary line L1 and the second auxiliary line L2, such embodiments are implemented only for convenience of understanding, and therefore one of ordinary skill in the relevant art would have understood that the number of the auxiliary lines may be increased or decreased as required, and the scope of the present invention is not limited according to the number of auxiliary lines.

In accordance with an embodiment, the auxiliary lines are closed curves and surround surfaces of different areas, respectively.

In accordance with an embodiment, as shown, for example, in FIG. 2, the respective auxiliary lines may share a center point positioned in a center of the folder screen 161.

As shown in FIG. 2, folders are disposed on the auxiliary lines, and a root folder FR is disposed at the center point.

Thus, in accordance with at least one embodiment, the root folder FR is disposed at the center point, a first layer folder is disposed on the first auxiliary line L1, and a second layer folder is disposed on the second auxiliary line L2. The first layer folder is a sub-folder of the root folder FR, and the second layer folder is a sub-folder of the first layer folder.

As the at least one auxiliary line and the folders disposed on the auxiliary lines constitute the folder screen 161 as described above, the folder screen 161 generated by the controller 140 is displayed on the display 160.

In accordance with an embodiment, the folder screen 161 is displayed over the entire display 160 or displayed only in some areas of the display 160.

The input device 110 receives a user's command and is implemented with typical input devices, such as a touch screen, a keyboard, a mouse, a mike, and a sensor, as non-limiting examples.

In accordance with an embodiment, the input processor 120 processes a signal input through the input device 110.

For example, when a user inputs a predetermined command through the input device 110, an abnormal input signal is generated due to an incorrect input or error of the input device 110 itself.

The input processor 120 detects and removes these incorrect inputs or abnormal input signals.

In accordance with an embodiment, the input processor 120 is configured to determine whether the input signal satisfies a predetermined condition and further configured to transmit the processed input data to the storage device 130, only when the condition is satisfied.

The storage device 130 stores the input data transmitted from the input processor 120. In accordance with an embodiment, the storage device 130 stores the type and coordinates of the user's command input through the input device 110.

For example, if the input device 110 is a touch screen provided in the display 160, the storage device 130 stores the user's touch position, touch number, existence of dragging in touch state, track of dragged point, as non-limiting examples of the input data.

In accordance with an embodiment, the controller 140 generates the folder screen 161 using the stored input data and processes the data to change the folder screen 161 according to the input data.

When the controller 140 generates the folder screen 161 by performing various operational processes, the generated folder screen 161 is stored in the storage device 130 first as the output data, and the display 160 outputs the screen according to the output data.

For example, as shown in FIG. 1, an area for storing the input data is shown as an input data storage device 131, and an area for storing the output data is shown as an output data storage device 133. In accordance with at least one embodiment, these input and output data storage devices 131, 132 are included in the storage device 130.

Next, the interface connector 150 is configured as a relay for connecting information data, which is obtained by digitizing various information such as folders and files, to the above controller 140 or storage device 130.

Various files, such as picture files, music files, and document files, as non-limiting examples, and folders that collect these files are stored in various types of memory or media, and used. In the various embodiments of the invention described herein, a person having ordinary skill in the art will recognize that various types of memory and media are readable by a computer, such as the memory and media described herein in reference to the various devices, e.g., storage device, input data storage device, output storage device, or other computers or processors with embodiments of the present invention. Examples of non-transitory computer readable media can include but are not limited to: nonvolatile, hard-coded type media, such as read only memories (ROMs), CD-ROMs, and DVD-ROMs, or erasable, electrically programmable read only memories (EEPROMs); recordable type media, such as floppy disks, hard disk drives, CD-R/RWs, DVD-RAMs, DVD-R/RWs, DVD+R/RWs, flash drives, memory sticks, and other newer types of memories; and transmission type media such as digital and analog communication links. For example, such memory or media can include operating instructions, as well as instructions related to the system and the method steps described above and can operate on a computer. It will be understood by those skilled in the art that such memory or media can be at other locations instead of, or in addition to, the locations described to store computer program products, e.g., including software thereon. It will be understood by those skilled in the art that the various software modules or electronic components described above can be implemented and maintained by electronic hardware, software, or a combination of the two, and that such embodiments are contemplated by embodiments of the present invention.

In accordance with an embodiment, these internal or external memory or media are connected to the above controller 140 or storage device 130 by the interface connector 150.

In accordance with an embodiment, the distance from the respective auxiliary lines to the center point positioned in the center of the folder screen 161 is adjusted, thus adjusting the circumferential length of the auxiliary lines.

Here, the auxiliary lines form various shapes of closed curves, but preferably have the same shape as the folder screen 161. Thus, when the folder screen 161 is implemented in a rectangular shape, preferably, each of the auxiliary lines is also formed in a rectangular shape, and when the folder screen 161 has a circular or oval shape, preferably, each of the auxiliary lines is also formed in a circular shape.

However, since the most recently released smartphones or tablets include a rectangular display device having a screen ratio of 3:4 to 16:9, it is most desirable that the folder screen 161 according to an embodiment of the present invention also has a rectangular shape to make full use of the display device.

Further, in accordance with an embodiment, the auxiliary lines may be formed of various lines such as solid lines or dotted lines having various colors.

Hereinafter, various embodiments of changing the folder screen 161 will be described with reference to the accompanying drawings.

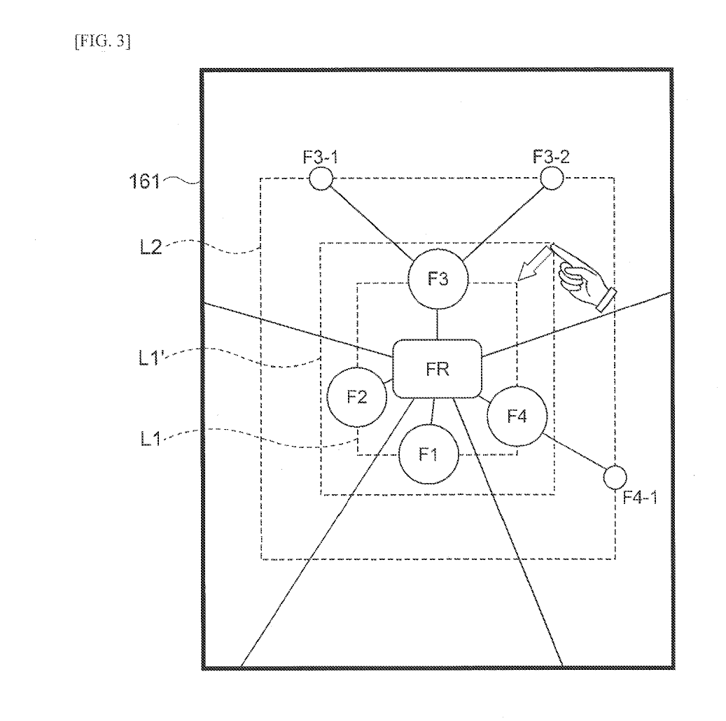

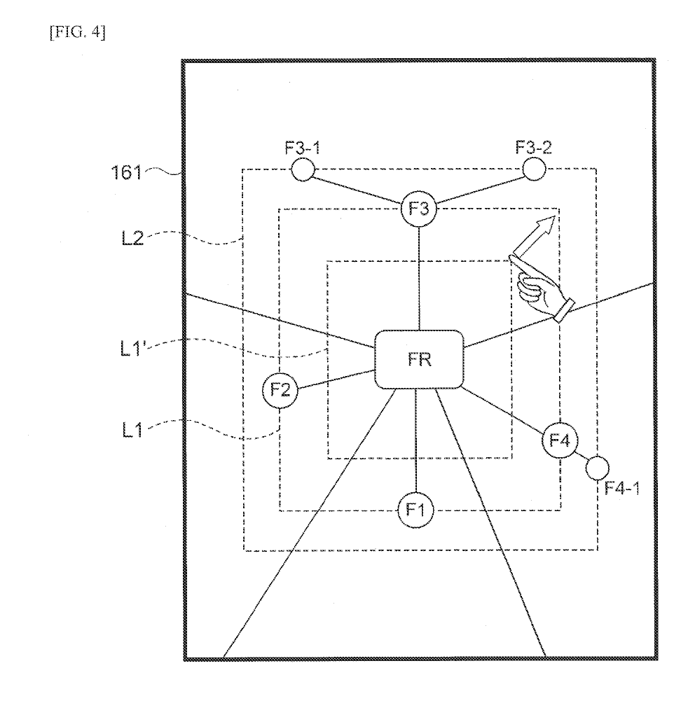

FIG. 3 is a view for explaining a principle that the size of the folder is increased in the folder screen 161 in accordance with an embodiment of the present invention, and FIG. 4 is a view for explaining a principle that the size of the folder is reduced in the folder screen 161 in accordance with an embodiment of the present invention.

First, referring to FIG. 3, when a selected point is moved in a direction closer to the center point in a state in which one point on the first auxiliary line L1′ is selected, the circumferential length of the first auxiliary line L1 is reduced, and thus the first auxiliary line L1 is changed to be closer to the center point.

Here, a method of selecting one point may be changed according to the type of the input device 110.

Thus, when the input device 110 is a touch screen, it is possible to select the point by touching the point, which is to be selected, on the touch screen with a finger, for example. Further, when the input device 110 is a mouse, it is possible to select the point by clicking left or right in a state of positioning a mouse pointer displayed on the folder screen 161 in the specific point.

In accordance with an embodiment, when the first auxiliary line L1 is changed to be closer to the center point in this manner, the size of a first folder F1, a second folder F2, a third folder F3, and a fourth folder F4, which are positioned on the first auxiliary line L1, is increased.

On the contrary, as shown in FIG. 4, when a selected point is moved in a direction away from the center point in a state in which one point on the first auxiliary line L1 is selected, the circumferential length of the first auxiliary line L1 is increased and thus the first auxiliary line L1 is changed to be away from the center point.

Further, when the first auxiliary line L1 is changed to be away from the center point, the size of the first to fourth folders F1 to F4, which are positioned on the first auxiliary line L1, are reduced.

Accordingly, it is possible to intuitively recognize upper and lower layer configurations between information, such as folders and files displayed on the folder screen 161. Further, it is possible to see the information around the center point in detail without changing the center point. Thus, it is possible to make use of a limited space more flexibly than before.

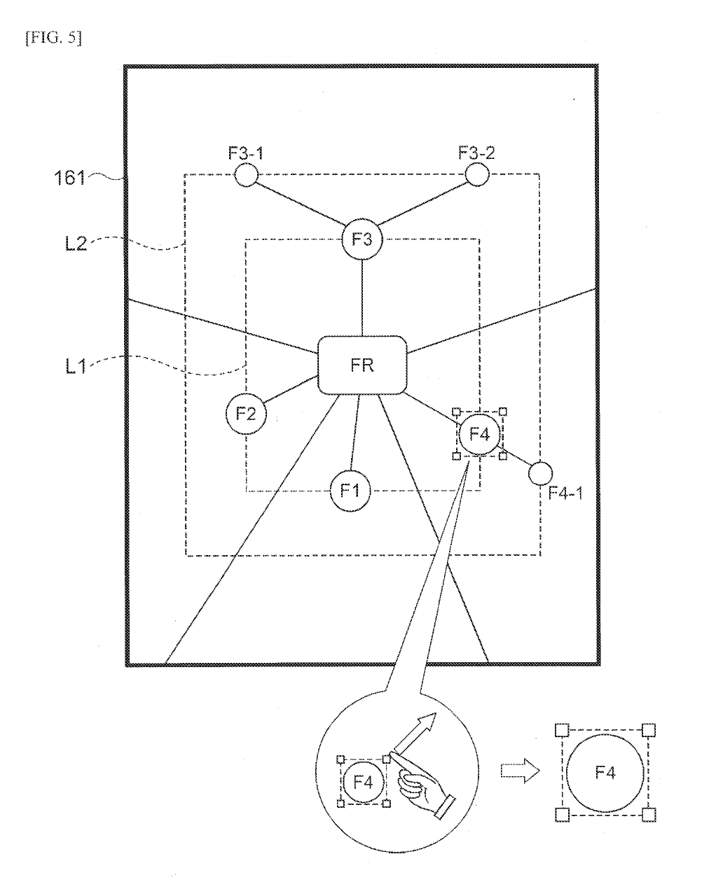

FIG. 5 is a view for explaining a principle that the size of the folder is increased in the folder screen 161 in accordance with another embodiment of the present invention.

Referring to FIG. 5, it will be understood that any one folder displayed on the folder screen 161 is selected and the size of the selected folder is changed. Thus, as shown, when the fourth folder F4 is selected, an outline is displayed around the fourth folder F4 and the size of the fourth folder F4 is increased by moving in an outer direction of the outline in a state in which the outline is selected.

In accordance with an embodiment of the invention, as the size of the fourth folder F4 is increased, the circumferential length of the first auxiliary line L1 is changed to be reduced.

Further, although not shown, the size of the fourth folder F4 is reduced by moving in an inner direction of the outline in a state in which the outline of the folder is selected.

When the circumferential length of the auxiliary line or the distance between the auxiliary line and the center point is changed to be associated with the size of the folder disposed on the corresponding auxiliary line, it is possible to secure consistency with the method of changing the folder screen 161 according to the embodiment described above with reference to FIGS. 3 and 4, consequently allowing a user to make use of the folder screen 161 more easily and intuitively.

In accordance with an embodiment of the invention, the size of the folder, which is the information adjusted along with the adjustment of the interval between the auxiliary lines, may not be larger than the size of a parent folder.

Accordingly, it will be helpful in intuitively recognizing a hierarchical structure between the folders.

Further, it is possible to check more detailed information about the desired folder, and if more space is needed, since it is only needed to adjust the interval between the auxiliary lines, it is possible to make use of a limited screen flexibly than before.

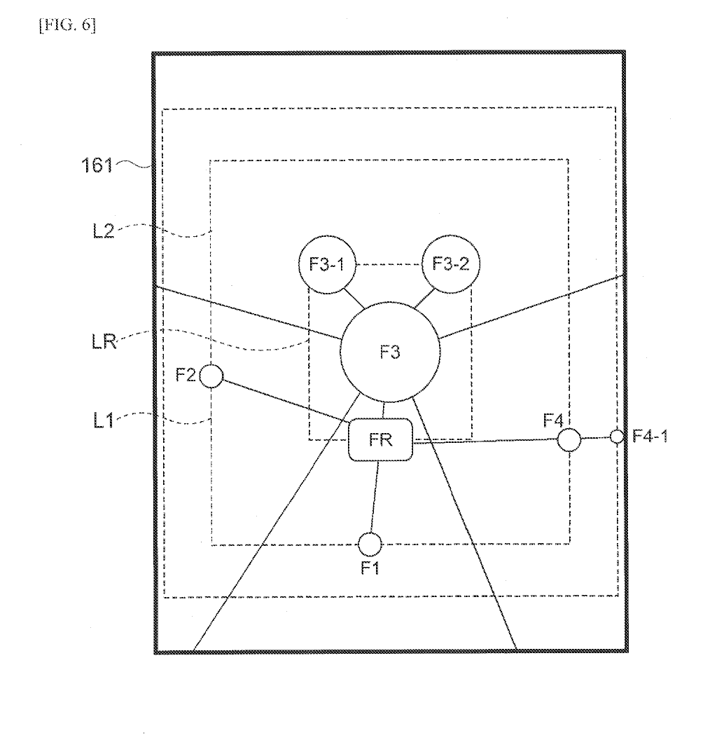

FIG. 6 is a view showing a state in which the folder screen 161 is rearranged around the selected folder in accordance with an embodiment of the present invention.

Referring to FIGS. 2 and 6, in a state in which the folder screen 161 is generated and displayed, as shown in FIG. 3, when the third folder F3 is selected by a predetermined method, the folder screen 161 is changed, as shown in FIG. 6. Here, the predetermined method includes, for example, double-touch or double-click and preferably determined to be different from the method of selecting the folder in the embodiment described above with reference to FIG. 5.

Thus, in accordance with an embodiment of the invention, when the third folder F3 is double touched, the third folder F3 is moved to the center point in which the root folder FR is positioned, and the folder screen 161 is changed so that the root folder FR, which is a parent folder of the third folder F3, and a third sub-1 folder F3-1 and a third sub-2 folder F3-2, which are sub-folders of the third folder F3, are disposed on the first auxiliary line L1.

Through the above method, it is possible to intuitively understand the hierarchical relationship of the information around the user's desired folder.

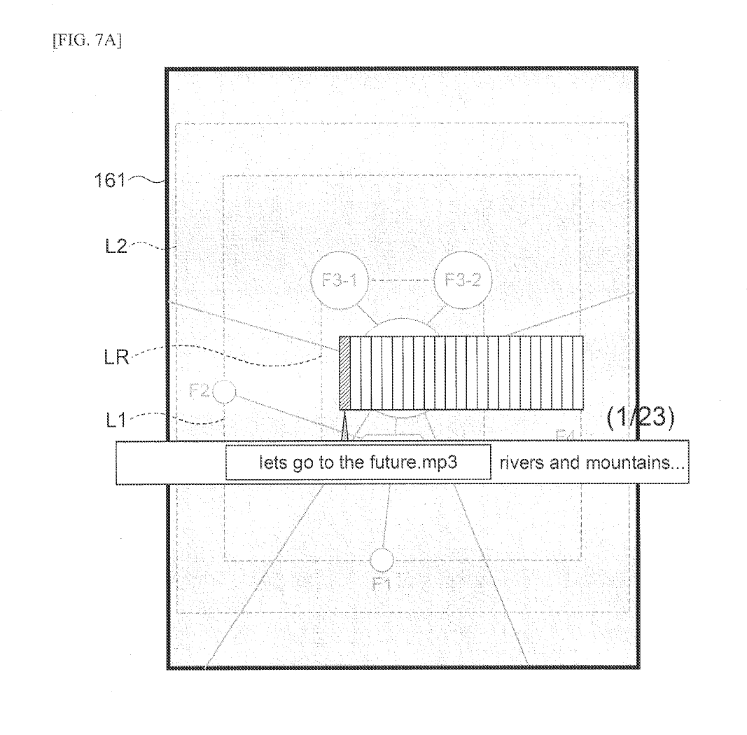

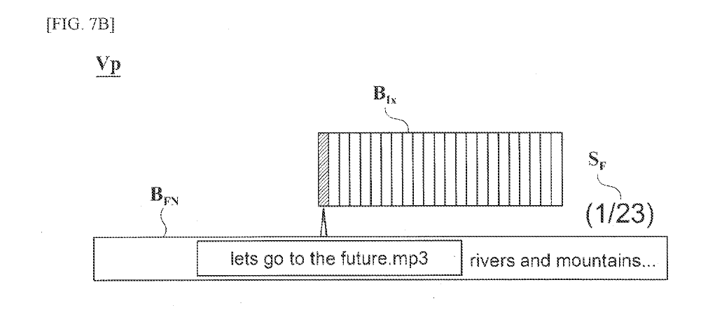

FIG. 7A is a view showing a state in which a preview Vp is displayed on the folder screen 161 of FIG. 6, and FIG. 7B is a view for explaining the preview Vp of FIG. 7A.

Referring to FIGS. 6 to 7B, it will be understood that the preview Vp is displayed according to touch in a state in which the third folder F3 is disposed in the center point.

In accordance with an embodiment of the invention, the preview Vp includes an index bar B_{IX} and a file name display bar B_{FN}.

The index bar B_{IX} represents each file included in the folder by a bar icon and be formed by arranging the bar icons continuously.

Further, the file name display bar B_{FN} displays a file name of the indexed file when the specific file is indexed on the index bar B_{IX}.

Further, in accordance with an embodiment, a file number S_{F} is further included in the preview Vp when necessary. Here, the file number S_{F} means that the total number of the files and a number of the file marked on the index bar B_{IX} are represented in figures.

Meanwhile, the preview Vp configured like this is displayed while being overlapped with the screen shown in FIG. 6. When the preview Vp is overlapped, the existing folder screen 161 is darkened, so that the user can concentrate on the preview Vp.

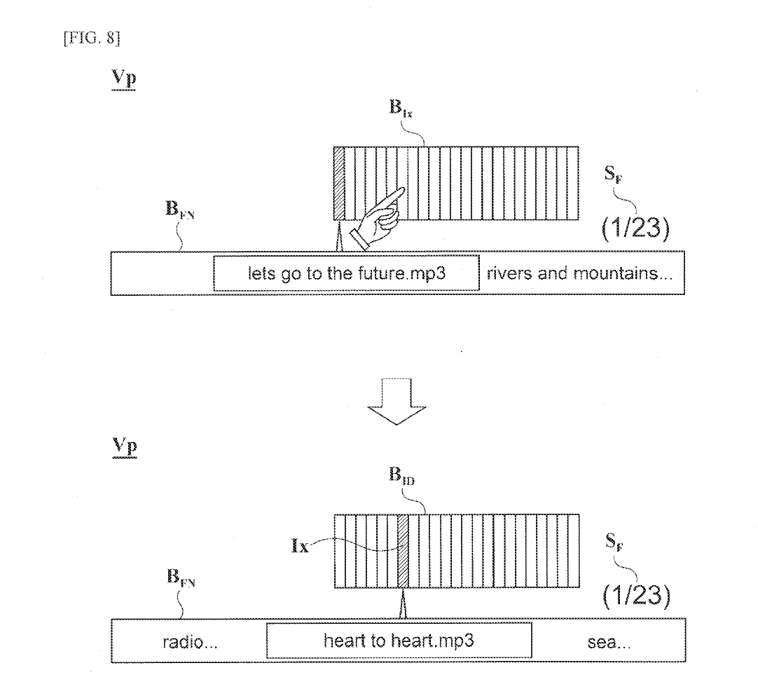

FIG. 8 is a view for explaining a principle of searching the file using the preview Vp in accordance with an embodiment of the present invention.

Referring to FIG. 8, it will be understood that the index is moved to the selected position and the file name of the indexed file is displayed on the file name display bar B_{FN}, when one portion of the index bar B_{IX} is selected.

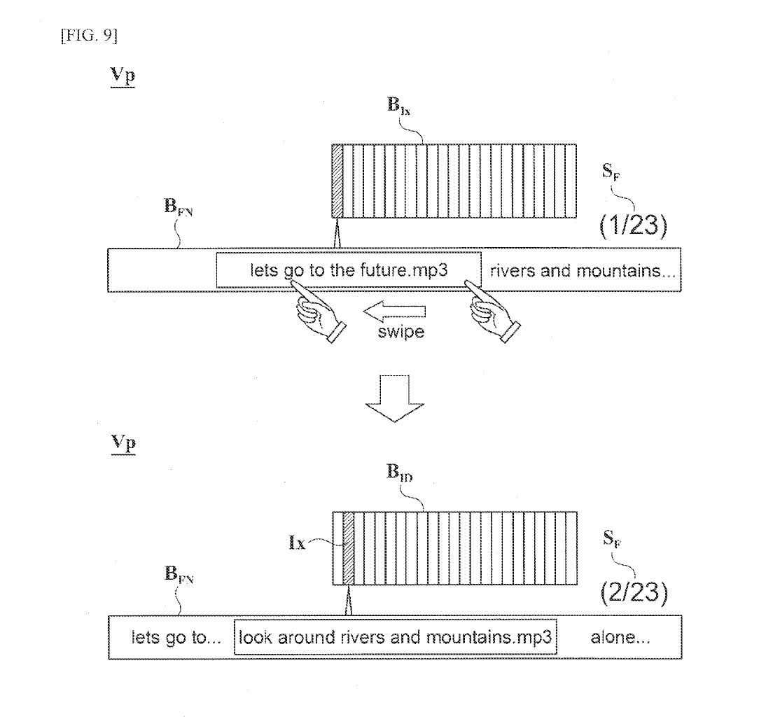

FIG. 9 is a view for explaining a principle of searching the file using the preview Vp in accordance with another embodiment of the present invention.

Referring to FIG. 9, it will be understood that the index is moved in a direction of the file having a lower number or the file having a higher number than the originally indexed file by swiping after selecting the file name display bar B_{FN}. Further, in this case, the file name displayed on the file name display bar BF also is changed and the file number S_{F} is changed as well. Further, it is possible to skip several files at a time by applying an inertia option to the swipe operation to increase the speed of the swipe operation.

In accordance with an embodiment of the invention, it is possible to execute the selected file by searching and selecting the specific folder and file in the above folder screen 161 through the method described above and double-touching or double-clicking the selected file.

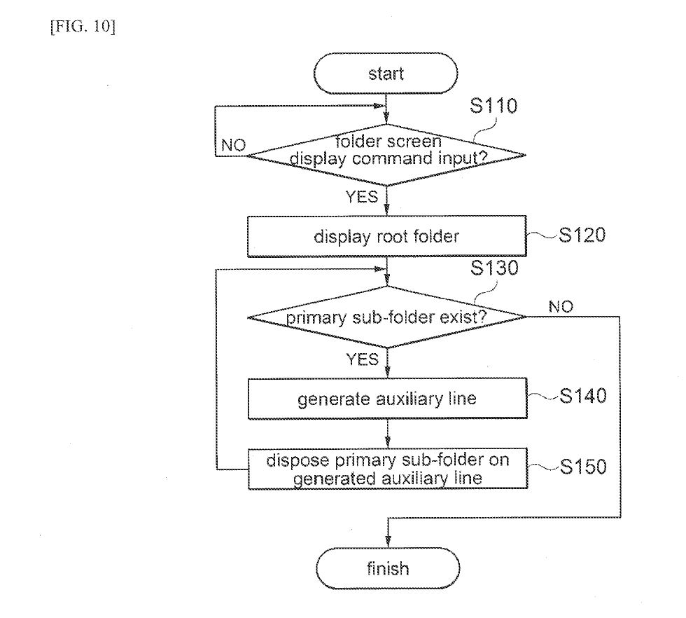

FIG. 10 is a flowchart schematically showing a method of displaying classified information in accordance with an embodiment of the present invention.

Referring to FIG. 10, the method of displaying classified information in accordance with an embodiment of the present invention includes generating an auxiliary line, and disposing a folder on the auxiliary line to display a folder screen 161.

First, when a command to display the folder screen 161 is input (S110), a root folder FR is selected first and the corresponding root folder FR is displayed in a center point of the folder screen (S120). Here, the root folder FR is selected by various methods. That is, the root folder FR in the folder screen 161 used just before or a top-level folder assigned by the default is assigned and displayed as the root folder FR.

Next, it is determined whether there is a sub-folder of the root folder FR (S130), the auxiliary line is generated when there is the sub-folder (S140), and the sub-folder is disposed on the generated auxiliary line (S150).

In accordance with an embodiment of the invention, the steps S130, S140, and S150 are repeated until there are no more primary sub-folders in the step S130, but since there is a limitation that the size of the folder screen 161 cannot be larger than the size of a display 160, the repetition of the steps S130, S140, and S150 is stopped when the size of a lowest folder, which is to be displayed on the folder screen 161, is smaller than a predetermined reference value.

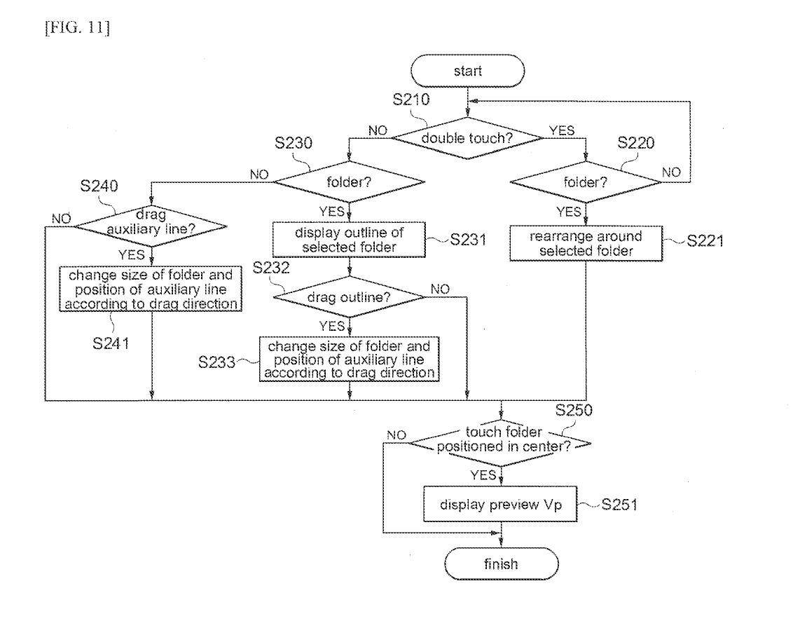

The folder screen 161 generated by the above method is changed in various ways as described above. Hereinafter, a principle of searching classified information using the folder screen 161 will be described with reference to FIG. 11.

FIG. 11 is a flowchart for explaining a principle of searching classified information in accordance with an embodiment of the present invention.

First, when the folder screen 161 is double touched, it is determined whether the double-touched object is a folder or not (S210, S220).

Next, the folder screen 161 is rearranged around the double-touched folder, when it is determined that the folder is double touched (S221). For example, in accordance with an embodiment of the invention, when a third folder F3 is double touched, the folder screen 161 is arranged as shown in FIG. 6.

In accordance with an embodiment of the invention, when the folder screen 161 is not double touched but touched, it is determined whether the touched object is a folder or not (S210, S230).

When it is determined that the folder is touched as a result of the step S230, an outline of the touched folder is displayed (S231), and the size of the folder is increased or reduced according to a drag direction when the outline is dragged (S233). At this time, the position of the auxiliary line is also changed along with the change in the size of the folder.

Further, when the touched object is not the folder but the auxiliary line, the position of the auxiliary line is changed according to the drag direction, resulting in the change in the size of the folder.

Meanwhile, when the folder positioned in the center point of the folder screen 161 is touched, a preview Vp is displayed as shown in FIG. 7A, and files are searched by using the displayed preview Vp as shown in FIGS. 8 and 9.

In accordance with at least one embodiment, the present invention configured as described above can intuitively recognize classified information even on a relatively small screen and efficiently search desired information.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A method of displaying classified information, comprising:
generating a first auxiliary line, which is a closed curve, and a second auxiliary line, which does not overlap with the first auxiliary line and surrounds a larger surface than an area of a surface surrounded by the first auxiliary line; and
displaying a folder screen generated by disposing at least one first layer folder on the first auxiliary line and disposing at least one second layer folder on the second auxiliary line, wherein the second layer folder is a sub-folder of the first layer folder.

2. The method of displaying classified information according to claim 1, wherein the first auxiliary line and the second auxiliary line share a center point positioned in a center of the folder screen.

3. The method of displaying classified information according to claim 2, wherein a root folder, which is a parent folder of the first layer folder, is disposed in the center point.

4. The method of displaying classified information according to claim 2, further comprising:
displaying the folder screen in such a way that the smaller the distance from the first auxiliary line to the center point, the larger the size of the first layer folder and the smaller the distance from the second auxiliary line to the center point, the larger the size of the second layer folder.

5. The method of displaying classified information according to claim 1, wherein the first auxiliary line and the second auxiliary line have a rectangular shape.

6. The method of displaying classified information according to claim 2, further comprising:
positioning a double-touched folder in the center point and disposing a parent folder and a sub-folder of the double-touched folder on the first auxiliary line when one folder selected from the first layer folder and the second folder is double touched.

7. The method of displaying classified information according to claim 2, further comprising:
displaying a preview which lists information of files included in a touched folder when a folder positioned in the center point is touched.

8. The method of displaying classified information according to claim 7, wherein the preview comprises:
an index bar formed by continuously arranging icons of the files according to a predetermined order; and
a file name display bar for displaying a file name of the file indexed on the index bar.

9. The method of displaying classified information according to claim 8, wherein the preview further comprises:
a file number consisting of the total number of the files and a number of the file indexed on the index bar.

10. The method of displaying classified information according to claim 2, further comprising:
displaying an outline of a touched folder when one folder selected from the first layer folder and the second layer folder is touched; and
changing a size of the touched folder according to a drag direction when the outline is dragged.

11. The method of displaying classified information according to claim 10, further comprising:
changing a distance from the first auxiliary line or the second auxiliary line on which the touched folder is disposed to the center point according to the drag direction when the outline is dragged.

12. The method of displaying classified information according to claim 10, further comprising:
when one auxiliary line selected from the first auxiliary line and the second auxiliary line is touched and dragged, changing a distance from the touched and dragged auxiliary line to the center point and the size of the folder disposed on the touched and dragged auxiliary line according to the drag direction.

13. A method of displaying classified information, which displays a folder screen generated by disposing at least one folder and a sub-folder of the folder on a plurality of auxiliary lines that are closed curves, which do not overlap with each other, and surround surfaces of different areas, respectively.

14. The method of displaying classified information according to claim 13, wherein the auxiliary lines are closed curves which share a center point positioned in a center of the folder screen.

15. The method of displaying classified information according to claim 14, wherein a size of the folder disposed on one of the auxiliary lines is changed when a circumferential length of the auxiliary line is changed.

16. The method of displaying classified information according to claim 15, wherein the size of the folder is proportional to a variation in the circumferential length of the auxiliary line.

17. The method of displaying classified information according to claim 16, wherein the auxiliary line has a rectangular shape.

18. A device for displaying classified information, which performs a method of displaying classified information according to claim 1, the device comprising:
a display configured to output a folder screen; and
a controller configured to generate the folder screen by generating a first auxiliary line and a second auxiliary line, disposing a first layer folder on the first auxiliary line, and disposing a second layer folder on the second auxiliary line.

19. The device for displaying classified information according to claim 18, further comprising:
an input device comprising at least one selected from the group consisting of a touch screen, a keyboard, a mouse, a mike, and a sensor to receive a user's command;
an input processor configured to process a signal input through the input device; and
a storage device configured to store input data processed by the input processor and output data generated by the controller.

20. The device for displaying classified information according to claim 18, further comprising:
an interface connector connected to the controller and the storage device configured to connect data, which forms folders and files, to the controller and the storage device.

21. The device for displaying classified information according to claim 18, wherein the input processor is further configured to transmit the signal input through the input processor to the storage device only when the signal satisfies a predetermined condition.

22. A device for displaying classified information, comprising:
a controller configured to generate a folder screen formed by disposing at least one folder and a sub-folder of the folder on a plurality of auxiliary lines that are closed curves, which do not overlap with each other, and surround surfaces of different areas, respectively; and
a display configured to output the folder screen.

23. The device for displaying classified information according to claim 22, wherein the auxiliary lines are closed curves which share a center point positioned in a center of the folder screen.

24. The device for displaying classified information according to claim 23, wherein a size of the folder disposed on one of the auxiliary lines is changed when a circumferential length of the auxiliary line is changed.

25. The device for displaying classified information according to claim 24, wherein the size of the folder is proportional to a variation in the circumferential length of the auxiliary line.

26. The device for displaying classified information according to claim 25, wherein the auxiliary line has a rectangular shape.
